(19) United States
(12) Patent Application Publication
(10) Pub. No.: US 2025/0165913 A1
(43) Pub. Date: May 22, 2025

(54) INTEGRATED LAND TRANSPORTATION MODE CONTROL SYSTEM

(71) Applicant: PT. Pertamina Patra Niaga Sub Holding C&T, Jakarta (ID)

(72) Inventors: . Giyarto; Bayu Riyadi; Asrul Rizai Ahmad Padilah; Dendi Triyandi, Jakarta (ID); . Haryanto, Jakarta (ID); . Iswahyudi, Jakarta (ID); Agung Budi Martin, Jawa Barat (ID); Eko Sulistyo, Jakarta (ID); Indraguna Kusuma B, Jakarta (ID); Rudy Permana, Jakarta (ID); Muhammad Antoni, Jawa Barat (ID)

(73) Assignee: PT. Pertamina Patra Niaga Sub Holding C&T, Jakarta (ID)

(21) Appl. No.: 18/546,426

(22) PCT Filed: Jul. 25, 2023
(86) PCT No.: PCT/ID2023/000001

§ 371 Date: Aug. 14, 2023

(30) Foreign Application Priority Data
Aug. 12, 2022 (ID) P00202208628

(51) Int. Cl. G06Q 10/0835; B60H 1/00; G06Q 10/0635; G07C 5/00

(52) U.S. Cl. CPC G06Q 10/08355; B60H 1/00978; G06Q 10/0635; G07C 5/008

(57) ABSTRACT

An integrated land transportation mode control system. The system is intended to be a center for processing information from information technology devices installed in land-wheeled vehicles including data (such as excess heat on the wheel drums, the opening and closing status from digital seals, the condition of air pressure on tires, the humidity in the cargo compartment driver's behaviour like fatigue level, drowsiness, calling while driving, safe driving distance, getting off the driving lane)

### FIELD OF THE INVENTION

This invention is related to an integrated land transportation control system. The system processes information from devices installed in wheeled-land vehicles including such data as: excess heat on the wheel drums, the opening and closing status from digital seals, the condition of air pressure on tires, the humidity and temperature on the device packing box, driver monitoring (for example, fatigue level, drowsiness, calling while driving, safe driving distance, deviating from the driving lane).

This information is combined with other information from operational control servers and other control servers, with the objective of getting complete information in an integrated manner from beginning to end.

### BACKGROUND OF THE INVENTION

In land transportation, ensuring the safety and efficiency of vehicles is of utmost importance. It is crucial to monitor and control various factors such as temperature, tire pressure, driver fatigue, and route conditions to prevent accidents and enhance transportation efficiency. Conventional systems often rely on manual checks or limited monitoring capabilities, which can be prone to human error and inadequate response times.

The development of information technology in daily life, especially in the business of companies that provide logistics services for goods and people, in line with reliable operational needs, must always be ready to support the business.

Logistics companies, when running their business, currently have many choices as to what they transport ranging from transporting passengers or goods, to transporting goods made of special materials, so innovation is needed to facilitate control and supervision and smooth operations assisted by information.

### SUMMARY OF THE INVENTION

The integrated land transportation control system processes data and information from sensor devices to applications to control center servers, as well as communication from control center servers to bases, vehicles, final destinations via the internet, as well as use in command centers. at the end user for both the base and the final destination.

Today's information technology is at the stage of the industrial era 4.0 with the basis of Internet of Things (IoT) technology, as well as the condition of the network infrastructure that is already 5G. This condition makes it possible for innovations to be realized and implemented in providing solutions for companies providing logistics services for people and goods.

The innovation in question is an idea that can be implemented, including the navigation method for land transportation vehicles that use a device that guides the driver while driving based on a navigation route. This navigation route may have been determined by the results of a logic tree analysis and the results of a risk and hazard identification study during the trip, as well as updating navigation data. The exact and effective innovation of navigation methods for land transportation is intended to improve driver safety performance and minimize traffic accident rates.

The intended innovation also includes a method of identifying the eligibility of land transportation drivers using devices that guide the driver before/or during preparation for driving based on the results of health condition checks (Fit To Work) and legality before being verified through the operations center server where the driver will verify and validate in the vehicle the suitability of the itinerary schedule and the exactitude of the status of the driver entering the itinerary schedule, as a support during the itinerary is also enriched with information from the navigation server, database server, as well as method information processing servers to minimize the risk of costs while on a long trip the higher it is.

Apart from the innovations mentioned above, these innovations also include safety methods for drivers of land transportation vehicles by using devices as driver guides before and/or preparation for driving, Where drivers receive information regarding safety procedures, and notifications related to an overheating condition in the vehicle's wheel drum, conveying information on legality sensors in the form of legality of vehicle certificates, conveying information on tire pressures, conveying Auto maintenance information on engine health conditions, during the trip the driver will be guided with Auto Navigation route information about directions (automatic destination routes), safe driving distance, and face fatigue information will be synchronized with the control level. This data center which becomes a learning engine as data analysis for driving safety.

The integrated land transportation mode control system consists of a terminal (90), which may include a terminal screen, a means for reading user input and to provide information by voice, which is configured to at least display information on the hot condition of the wheel drums. under normal conditions or not on the interface terminal display (90) via overhead drum sensor (12); displays information on tire under normal conditions or not on the interface pressure terminal display (110) via the tire pressure sensor (13), displays warning information on safe driving distance (14) with other vehicles in front of it via loudspeaker (7) and interface terminal display (110), displays the face fatigue information (17) via loudspeaker (7) located on the interface terminal display (110), sounds safety induction information (11) via loudspeaker (7) to the driver, displays, data safety induction, shipping information, travel routes and travel risks. If driver's input data (10), the trip schedule data and the health condition examination result data are verified, information that the driver must rest and/or report to the administration will not be shown. If the driver's input data (10), data on travel schedules and data on results of health checks are not verified, displays travel route information automatically (15) to the destination and is enriched with travel route information from the database control server (40b) on the interface terminal display (90), receives input data from the identification (30) biometric sensor and/or RFID card and/or NFC and/or e-button on the terminal (90) as a user interface, then the input data is sent to an operations server (40a) and a database control server (40b); a blackbox data recorder (91) connected to a terminal, which is configured as a minimum to receive data on the overheat status of the wheel braking components from the wheel drum temperature sensor (93), process the overheat status data, then send it to the terminal, receive and process the information data condition of wind pressure on the valve received from the pneumatic pressure sensor (92), then sends it to the terminal, receives and processes information data on humidity and electrical conditions received from the humidity sensor (94), then sends it to the terminal, receives commands from the terminal to open the seal digital, Advance Driving Assistant System ADAS (107) connected to an information processing server (40d) including a means for displaying voice alerts and notifications (108) connected to a video acquirer, a video camera (109) integrated with a GPS connected to a information processing server (40d) configured as a minimum to acquire video of the driver's face to detect driver fatigue and violations, and acquire video of the front of the vehicle to assess the driver's driving behavior; operations server (40a) configured to store route plans and sensor data (drum, pneumatic seals, digital seals, driver behavior); database control server (40b) configured to store input data from biometric and/or RFID card sensors and/or NFC and/or e-button on terminal (90), verify input data (60) from biometric and/or RFID card and/or NFC and/or e-button through the terminal (90), if verified, the itinerary data will be sent by the operations control server (40a) to be displayed to the terminal (90); forwards update data on situation and condition through trip data recorder (70), then updates data center on database control server (40b) from terminal (90) via the internet (50) and updates database control server (40b) at control center server (40) based on data received from terminal (90) as machine learning to provide itinerary data and identification of risks and hazards of subsequent journeys, navigation control center server (40c) configured to store electronic navigation charts; information processing server (40d) connected to a terminal configured as a minimum to receive data from a video acquirer, receive navigation data, fuel consumption data, and send them to the terminal, receive shipping data and send them to the terminal; a tire pressure sensor (95) connected to a terminal configured to capture tire pressure data and then transmit the data to the terminal.

Other objectives and benefits as well as a more complete understanding of the following invention as a preferred embodiment and will be explained with reference to the attached drawings.

### BRIEF DESCRIPTION OF THE DRAWINGS

FIG. 1 illustrating the is a network diagram interconnection of data and information communications from control center servers, bases, vehicles, final destinations as well as with third-party servers in an integrated land transportation mode control system according to the present invention.

FIG. 2 is a network diagram illustrating the utilization of data and information at the head office, at the base and at the final destination according to the present invention.

FIG. 3 is a block diagram illustrating the details of interconnection locally on the sensors installed in the vehicle up to the interconnection to the central control server via the internet according to the present invention.

FIG. 4 is a block diagram of a land transportation mode navigation system according to the present invention.

### DETAILED DESCRIPTION

This invention will be fully described with reference to the figures attached.

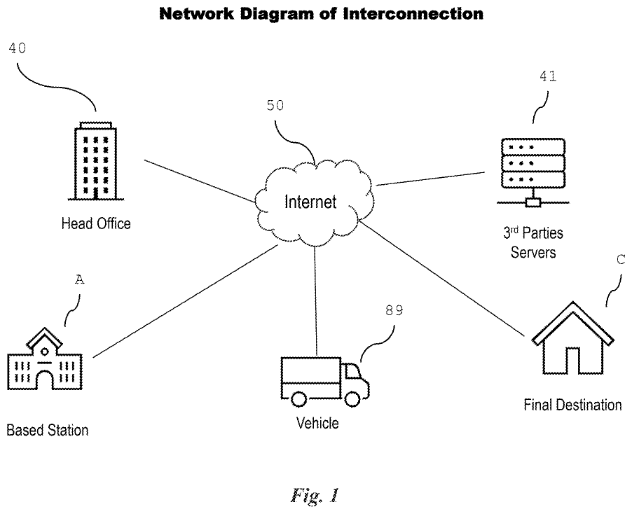

FIG. 1 shows images of data and information communication interconnections from control center servers (40), bases (A), vehicles (89), final destinations (C) as well as with third-party servers (41) in land transportation mode control systems in an integrated manner via the internet (50), namely:

Data records that occur on the sensor device and installed applications can be monitored on the vehicle (89), while the information in question is in the form of excess heat on the wheel drum, the status of opening and closing the digital seal, the condition of the tire pressure, the temperature humidity in the device packaging box, which then stored on a local data recording device called an Electronic Data Recorder (EDR) or blackbox data recorder (91).

Other information such as behavior, driving level of fatigue, drowsiness, driving telephone, safe driving distance, exiting the driving lane, and the final position of the vehicle installed in the vehicle will be cabin uploaded for synchronization of data on a third-party server (41), then this information can be downloaded and processed on the information processing server (40d), via the internet (50).

As long as the vehicle (89) is at the base (A), in order to prepare everything for the descent, after the vehicle (89) is ready for the retreat, then when the vehicle (89) leaves the base (A), the system on the information processing server (40d)) will automatically send information to the social media control server (40e) to then send a one-time key pin or One Time Password (OTP) to users who are at the final destination (C) via the internet (50).

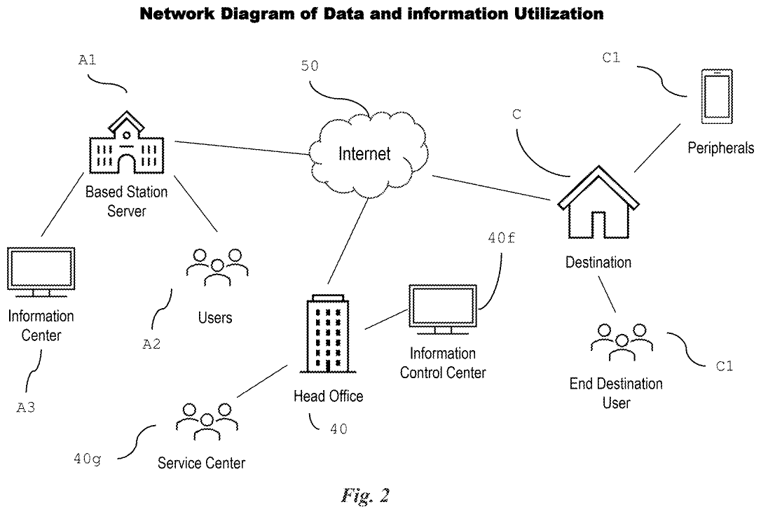

FIG. 2, provides images of data and information utilization at the head office, at the base and at the final destination are shown, namely:

Utilization of data and information at the head office that is managed and processed on the control center server (40), which among other things is processed on the operations control center server (40a), on the database control server (40b), on the navigation control center server (40c), on the information processing server (40d) and on the social media control server (40e).

Data and information presented in the form of reports and displayed through dashboards or panels in the information control center room (40f) at the head office. This is done to support smooth operations during operations assisted by a service and call center (40g) located at the head office to support information needs originating from users from the base (C), users from the final destination (C1). This communication uses the internet (50) both signal and data.

Utilization of data and information in the base will be in the form of data and information presented to base users (A2) in the form of reports and displayed through dashboards or panels in the base local information center (A3) room, originating from the base server (A1) which the information is synchronized from the control center server 40 via the internet.

Utilization of data and information at the Final Destination (C) by the user (C1) in the form of information on the status and position of the vehicle (89) at the final destination (C) originating from the operations control center server (40a)/or can also originate from the information processing server (40d), primarily information regarding one-time key pins or One Time Password (OTP). This information can be accessed by the final destination user (C1) on a computer device, smartphone (C2) by the user (final destination (C1) via the internet (50).

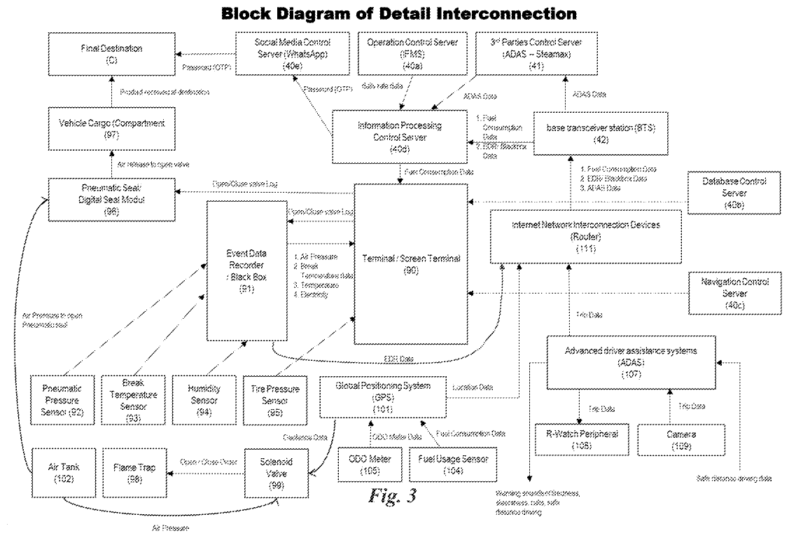

FIG. 3, provides a detailed image of the interconnection that occurs locally on the sensors installed in the vehicle up to the interconnection to the control center server via the internet is shown. Humidity, temperature on the device packing box, the legality status of the vehicle certificate, travel routes, are displayed on the vehicle terminal screen (90) and are also conveyed in the form of beeps and warning sounds. Information regarding driving behavior, level of fatigue, drowsiness, driving telephone, safe driving distance, exiting the driving lane, and the final position of the vehicle is not displayed on the vehicle terminal screen (90) but is conveyed in the form of beeps and warning sounds to the driver for incidents. from one of these and/or other conditions, for interconnection flow details namely:

The pneumatic pressure sensor (92) functions to capture pressure data coming from the air compressor, then this information is forwarded via a data cable connection locally as input data in a local data recording device called an Electronic Data recorder (EDR) or blackbox data recorder (91), then will be forwarded as input data and displayed on the vehicle terminal screen (90) as a source of information which is followed up in the form of beep sound warnings and/or human voices through the loudspeakers on the vehicle terminal screen (90).

The wheel drum temperature sensor (93) captures temperature data on the wheel drum, then this information is forwarded via a data cable connection locally as input data in a local data recording device called an Electronic Data Recorder (EDR) or blackbox data recorder (91). as well as being forwarded as data input and displayed on the vehicle terminal screen (90) as a source of information which is followed up in the form of beep sound warnings and/or human voices via loudspeakers on the vehicle terminal screen (90).

The humidity temperature sensor (94) captures temperature humidity data and capture electrical power data whether it is still under normal or abnormal voltage, then this information is forwarded via a data cable connection as data input to the blackbox data recorder (91), and will be forwarded as data input and displayed on the vehicle terminal screen (90) as a source of information which is followed up in the form of beep sound warnings and/or human voices through the speakers on the vehicle terminal screen (90).

The tire pressure sensor (95) functions to capture tire pressure data, then this information is forwarded via a data cable connection locally as input data and displayed on the vehicle terminal screen (90) as a source of information which is followed up in the form of beep sound warnings and/or or a human voice through the loudspeaker found on the interface terminal display (110).

The terminal screen (90) will receive data input data processing from the information processing server (40d) which is also connected to the operations control center server (40a). The data consists of the driver's name, final destination address, order code number.

On the terminal screen (90) which has received data input from the information processing server (40d) which has also been connected to the operations control center server (40a) will also receive input data from the driver as confirmation that the driver has been scheduled on the control center server system. operation (40a).

On the terminal screen (90) which has received input traffic data from the information processing server (40d), it also receives data input from the database control server (40b) in the form of situation and road conditions in the form of data on geography, level of activity crowd schools, the level of crowds in the spill market, the number of traffic signs that are passed, the position and number of bridges, the class of roads that are traversed.

The terminal screen (90) which has received the route data input from the information processing server (40d), also receives input to enrich it with road route information from the navigation control center server (40c).

The information processing server (40d) will automatically send information to the social media control server (40e) to then send an integrated one-time password (OTP) key to the user at the final destination (c).

The pneumatic seal or digital seal (96) sensor functions to capture wind data sent from the air tank (102) via a pneumatic hose, whose function is to condition that the valve is always closed or normally closed, the pneumatic seal sensor or digital seal (96) will receive input data from the vehicle terminal screen (90) as an order to release or exhaust air to open the valve, in which this command is in the form of a single-use lock pin or one time password (OTP) entered by the user at the final destination (C) as well as other input in the form of confirmation of data validation originates from the card affixed to the vehicle terminal screen (90) by the user at the final destination (C), as a complement to the confirmation for opening or closing the valve in the cargo compartment (97), the activity of opening/closing the valve of the pneumatic seal or digital seal (96). sent to a local data recording device called an Electronic Data Recorder (EDR) or blackbox (91). In the cargo vehicle or cargo compartment (97) it receives a release condition or input from the pneumatic seal sensor or digital seal (96) as a valve open command.

On the information processing server (40d), in addition to receiving input data from the operations control center server (40a) in the form of retrieval data, it also receives input data from a third-party server (41) from Advanced Driver Assistant System (ADAS) (107) for data in the form of fatigue, drowsiness, driving telephone, safe driving distance, exiting the driving lane, where previously data was sent via Base Transmit Station or BTS (42).

The information processing server (40d) also receives data input from the form of fuel consumption device (104) and data in the form of excess heat on the wheel drums, the status of opening and closing digital seals, the condition of tire pressure, humidity temperature in the device packaging box, which originates from a local data recording device called an Electronic Data Recorder (EDR) or blackbox data recorder (91), via an internet network interconnection device (111).

The video camera (109) captures the driver's activity data in the form of fatigue, drowsiness, driving telephone, safe driving distance, exiting the driving lane and these data become input to the Advance Driver Assistant System (ADAS) (107).

The Advanced Driver Assistant System (ADAS) (107) sends display data and beeps for safe driving distances to the R-watch device (108), as well as informs through loudspeakers warning levels of fatigue, drowsiness, telephone driving, safe driving distance. The Global Positioning System or GPS (101) receives input data in the form of an ODO meter (105), a fuel consumption device (104) in which the data is sent to the information processing server (40d) through the Base Transmitter Station or BTS and through the internet network interconnection device (111), for example a router.

The flame trap (98) will function when driven by the solenoid valve (99) which gets pressure from the air tank (102) and gets data input from the Global Positioning System or GPS (101) with a location that has been virtually or geofence.

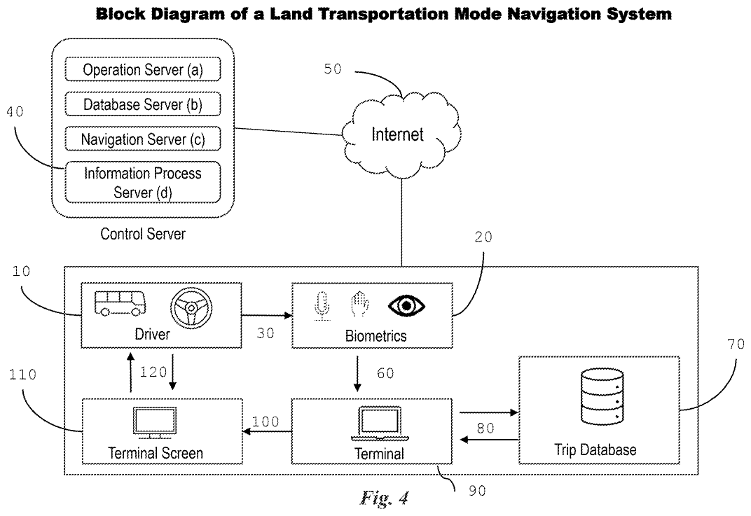

FIG. 4, shows a diagram of the relationship between the driver's input data (10) and face-to-face contact between users through the interface terminal display (110) in which the driver touches/attaches identification (30) to the authentication device (20) which can be a Biometric/NFC/RFID/e-Button and the verify input data (60) is sent to the terminal device (90) as a verification of the driver's schedule which is on retracement or not, the results of the reading are adjusted to the daily trip data to the data center for example on the operation control server (40a) if it is not correct then the driver cannot carry out retrievals (round trips (regarding public transportation such as buses, minibuses) in one route), if the verification results are appropriate, the retrieval data will be obtained from the data center which can be in the form of an operation control server (40a) and be informed in the form of images on the interface terminal display (110) and voice messages on the terminal (90) in the form of geographical data, the level of school activity crowds, the crowd level of the spill market, the number of traffic signs to be passed, the position and number of bridges, the class of road to be traversed from the database control server (40b) as well as the route of the electronic navigation map (GPS) which must be traversed automatically taken from the data center for example the navigation control center server (40c) and then displayed on the terminal (90) via (100) the interface terminal display (110). If during the trip the situation and conditions still match the data and information in the data center, for example on the database control server (40b), then the display of images and special voice messages for drivers on the terminal (90) will only be in the form of geographical data, the level of school activity, the level of crowding of the spilled market, the number of traffic signs to be traversed, the position and number of bridges, class roads to be traversed come from for example the database control server (40b).

However, if there is a change in data and information that is not appropriate, the updated data on the situation and condition is forwarded through (80) the travel data record (70) then a data synchronization will be carried out in the form of geographical data, school activity crowd level, market crowd level, the number of traffic signs to be passed, the position and number of bridges, the class of roads to be traversed as a follow-up for updates to the data center for example on the database control server (40b) from the terminal (90) via the internet (50).

The transportation management system incorporates a vehicle equipped with a Blackbox data recorder. This device gathers essential data about the vehicle, which may be a fuel tanker. The black box data recorder communicates data to a central server which analyzes the information, the analysis maybe done in real-time or close to real-time.

The system may identify potential safety issues, such as brake overheating. On detecting any such issue, it may generate safety alerts that are immediately communicated to the driver.

The system may be capable of generating a safer transportation route to further augment safety. This function may take into account the possibility of brake overheating during downhill driving.

The system determine the maximum amount of cargo that can be safely loaded onto the vehicle, specifically considering the chances of brake overheating during downhill travel. Based on this calculation, the cargo is loaded to ensure that the vehicle is not overloaded and that safety is maintained.

Driving behavior data may include information on stopping too long in a place, cornering too sharply, pressing a brake pedal too hard and frequently, exceeding a preset speed and other information about driving actions that may relate to safety.

Facial fatigue information may include information on level of fatigue, drowsiness, yawning, using communication devices, not concentrating on driving and other data.

The description above has been provided for illustrative purposes. It should be understood by those skilled in the art to which the invention relates that this invention can be easily forms without deviating from the realized in many different technical idea or essential features thereof. Thus, the embodiments stated here should be considered in a descriptive sense only and not for restrictive purposes.

The scope of this invention is defined in the following claims. Thus, it should be understood that this invention includes all of those modifications provided that are within the scope of the attached claims.

1. An integrated land transportation system comprising:
a. vehicle with a terminal and a blackbox data recorder connected to the terminal where the terminal displays itinerary data; and the blackbox data recorder receives and processes sensor data, where sensor data includes brake temperature; and
b. database control server connected wirelessly to the blackbox data recorder that verifies the itinerary data is received by the terminal;
where the blackbox data recorder forwards sensor data to the database control server, and the database control server uses the sensor data and machine learning to provide the itinerary data.

2. The integrated land transportation system of claim 1 further comprises a digital seal module configured to receiving a command from the blackbox data recorder to open a digital seal on a vehicle cargo compartment.

3. The integrated land transportation system of claim 2, where the terminal further displays digital seal data.

4. The integrated land transportation system in accordance with claim 1, where the itinerary data includes trip data from machine learning analysis.

5. The integrated land transportation system claim 1, where in-transit risk data contained in a road risk control management system becomes the main data base/data integrated with an electronic navigation map (GPS) on navigation control server.

6. The integrated land transportation system of claim 1, where the itinerary data includes updates based on human trip risk data.

7. The integrated land transportation system of claim 1, where itinerary data includes trip route information from the database control server that comprises road situation and condition, crowd level data, school activities, market crowd level.

8. The integrated land transport system of claim 1, where blackbox data recorder records driving behavior data.

9. The integrated land transportation system of claim 1, where system records facial fatigue information.

10. The integrated land transportation system of claim 1, where the terminal obtains trip itinerary plan information from an operations control server that includes driver data which is scheduled daily iteration which becomes data and comparison information on legitimacy of daily driver commute.

11. The integrated land transportation system of claim 1, where the terminal sends brake temperature and tire pressure sensors to an operations control center server.

12. A transportation management system, comprising:
a. vehicle with a blackbox data recorder configured to collect data about the vehicle; and
b. a central server, operatively coupled with the blackbox data recorder, configured to receive and analyze the data from the blackbox data recorder.

13. The transportation management system of claim 12, where the vehicle is a fuel tanker.

14. The transportation management system of claim 12, where the system is further configured to provide real-time safety alerts to a driver of the vehicle upon identification of potential safety issues including brake overheating.

15. The transportation management system of claim 12, where the system generates a safer transportation route.

16. The transportation management system of claim 15, where the generating the safer transportation route includes calculating if the route is likely to cause brake overheating from going downhill.

17. The transportation management system of claim 15, where the generating the safer transportation route includes calculating the maximum amount of cargo to be loaded based on calculating brake overheating on downhill portions of the transportation route.

18. The transportation management system of claim 17, where the vehicle is a tanker truck and the cargo is liquid fuel.

19. The transportation management system of claim 17, where the cargo is loaded based on the calculate maximum amount of cargo.

20. The transportation management system of claim 19, where the vehicle is a tanker truck and the cargo is fuel and the fuel loaded is based on the calculate maximum amount of cargo.
